(19) United States
(12) Patent Application Publication
(10) Pub. No.: US 2002/0114311 A1
(43) Pub. Date: Aug. 22, 2002

(54) Continuous allocation of real-time traffic in a telecommunication system

(76) Inventors: Sara Mazur, Bromma (SE); Christofer Lindheimer, Kista (SE); Mathias Eriksson, Uppsala (SE)

Correspondence Address: Richard J. Moura, Jenkens & Gilchrist, P.C., 3200 Fountain Place, 1445 Ross Avenue, Dallas, TX, 75202-2799, US

(21) Appl. No.: 09/788,055

(22) Filed: Feb. 16, 2001

(51) Int. Cl. H04B 7/212

(52) U.S. Cl. 370/347; 370/442; 370/468; 370/522

(57) ABSTRACT

A method for continuous allocation of real-time (e.g., speech) traffic in a communication system is disclosed, whereby a network allocates, for a timeslot or other medium, a unique radio block for real-time traffic that immediately succeeds a control block (or block otherwise non-allocable for real-time traffic) which is also allocated for that timeslot. The unique radio block is allocated to carry the unit of real-time traffic displaced by the control block, along with the next unit of real-time traffic. The two units of real-time traffic in the allocated radio block are each conveyed in a half-rate mode, while the real-time traffic in a normal radio block is conveyed in a full-rate mode. In this way, the output signals of, for example, a speech codec can be continuously allocated for transmission.

### BACKGROUND OF THE INVENTION

1. Technical Field of the Invention

The present invention relates in general to the wireless communications field. More specifically, the invention relates to a method and apparatus for allocating real-time services in a cellular telecommunication system.

2. Description of Related Art

There is a trend in the telecommunications community to focus more and more on wireless packet data communications rather than wireless circuit-switched communications. With the tremendous increase of Internet users, and usage of Internet protocols, it is believed that the packet-switched communications will soon become larger than the circuit-switched communications today dominating the cellular industry. Cellular communication system manufacturers and operators are therefore looking for solutions to integrate their circuit-switched services with wireless packet-switched services that can provide reliable and more spectrum efficient connections for packet-switched users (e.g., Internet users). This trend has made different types of packet-switched communication system evolutions flourish. One of the more well known packet-switched cellular systems is the extension of the present Global System for Mobile Communications (GSM) cellular communication system, called the General Packet Radio Service (GPRS).

GPRS is a packet-switched system that uses the same physical carrier structure as the present GSM cellular communication system, and is designed to coexist and provide the same coverage as the GSM. The GPRS radio interface is thus based on a Time Division Multiple Access (TDMA) structured system with 200 kHz carriers divided into eight timeslots with Gaussian Minimum Shift Keying (GMSK) modulation. The multiplexing is such that multiple users can be allocated on the same timeslot, and utilize resources only when data needs to be transmitted. A single user can also be allocated multiple timeslots to increase its throughput of data over the air.

The GPRS specification includes a number of different coding schemes to be used which are dependent on the quality of the radio carrier. With GPRS, data rates well over 100 kbps will be possible. There has also been a development and standardization of a new air interface mode in the GSM, which will affect both packet- and circuit-switched modes. This new air interface mode is called Enhanced Data Rates for Global Evolution (EDGE). The main features of EDGE are new modulation and coding schemes for both packet-switched and circuit-switched data communications. In addition to GMSK modulation, which is used today in both GPRS and GSM circuit-switched modes, an 8-symbol Phase Shift Keying (8PSK) modulation has been introduced. This modulation can provide users with higher data rates than GMSK in good radio environments.

The packet data mode with EDGE modulation is called Enhanced GPRS (EGPRS), and the circuit-switched data mode is called Enhanced Circuit-Switched Data (ECSD). With EGPRS and 8PSK modulation, data rates over 384 kbps will be possible.

A recent development for another TDMA-based cellular system, the cellular system compliant with the ANSI/136 standard (referred to hereinafter as TDMA/136) has been focused on a packet data system to be integrated with the TDMA/136 circuit-switched mode. This packet data system will also be based on the new EDGE technology as defined for the GPRS extension. It will then provide TDMA/136 operators with a packet data mode to offer data rates up to 384 kbps on 200 kHz carriers with GMSK and 8PSK modulation as defined for EGPRS.

Reuse patterns are deployed in cellular systems, such that one can reuse the same frequencies in different cells. Systems are usually planned such that a number of cells share a number of available channels. For example, in a 4/12 frequency reuse, there are 4/12 different cells that share a set of frequencies. Within these 4/12 cells, no frequency is used in more than one cell simultaneously. (The number “4” in “4/12” denotes the number of base station sites involved in the 12 reuse. The 4/12 denotation thus indicates that a base station site serves 3 cells.) These 12 cells then form what is referred to as a cluster. Clusters are then repeated to provide coverage in a certain area.

Similarly in a 1/3 reuse, there are 3 different cells that share a set of frequencies. Within these 3 cells, no frequency is used in more than one cell simultaneously. Thus, the lower the reuse (e.g., 4/12), the better the carrier-to-interference ratio for an exemplary condition. For higher (e.g., 1/3) reuse patterns, the carrier-to-interference ratio is lower, because the distance between two base stations transmitting on the same frequency is shorter. An exemplary 1/3 reuse pattern is illustrated in FIG. 1.

GPRS channels typically have different levels of robustness demands, depending on the type of logical channel being transmitted. (A logical channel is defined by its information content and is transmitted on one or several physical channels, defined by the physical channel structure, such as for example, a timeslot on a certain frequency). In a packet data system, reliance on retransmission possibilities can allow a quite high error rate, which means that the reuse for user data traffic channels can be kept quite low. For example, a data traffic channel can be deployed in a 1/3 reuse, whereas common control channels and broadcast channels are not robust enough to be allocated in a 1/3 reuse, because the same retransmission possibilities are not available for these types of logical channels. At least a 3/9, or even a 4/12 reuse, is recommended for packet data common control and broadcast channels.

Note that a 3/9 reuse means that at least nine 200 kHz carriers are needed (i.e., TDMA/136 operators must provide at least 1.8 MHz of spectrum for an initial deployment). This is considered quite substantial in a TDMA/136 system, which otherwise utilizes 30 kHz carriers for their circuit-switched voice communications.

This fact has driven the TDMA/136 community to find other solutions for initial deployment of a packet data system based on EDGE and GPRS. U.S. patent application Ser. No. 09/263,950, entitled “High Speed Data Communication System and Method”, to Mazur et al, which is incorporated herein by reference, teaches a method for combining TDMA/136 and the EGPRS mode of EDGE.

Briefly, the solution is to place requirements on the base station transmissions of the EDGE carriers. Base station transmissions of EDGE carriers should be time synchronized. It is then possible to allocate the control channels on different frequencies and different timeslots in different cells, and thereby construct a higher reuse than what is possible by only considering frequencies. This solution is often referred to as EDGE Compact. In addition to frequency reuse, a time reuse is introduced. For example, a certain base station transmits control signalling on a certain timeslot at a certain time and on a certain frequency, at which no other base station in the same control channel cluster (i.e., all cells where each physical channel carrying control signalling is used only once) is transmitting anything at all. This is repeated between a number of base stations, such that different time groups are formed. Furthermore, to increase the reliability of control channel detection in the mobile stations and base stations, respectively, timeslots adjacent to each other do not both carry control channel information.

EDGE Compact provides the opportunity to introduce a higher reuse than that allowed by frequency repetition only. Thus, it will be possible to allow an initial deployment of a GPRS/EGPRS packet data system within a spectrum bandwidth much smaller than that otherwise limited by the reuse requirement for the control channels. In FIG. 2, a typical allocation for the control channels is illustrated. Therein, four different time groups are illustrated on a single frequency (i.e., a 4× time reuse is formed). In one cell, control information is transmitted in timeslot 1 (TS1), or in other words, time group 1 (TG1), in certain defined GSM frames. Base stations transmitting control information on the same frequency, but belonging to another group, will not transmit at all during the frames that are used for control in base stations belonging to TG1. In another cell, control information is transmitted in TS3 (i.e., TG2), again in certain GSM frames. Base stations transmitting control information on the same frequency but belonging to another time group, will not transmit at all during the frames that are used for control in base stations belonging to TG2. Similar reasoning applies for TS5 and TS7. Combining the time reuse with, for example, a 1/3 frequency reuse, it is possible to transmit control information in an effective 4/12 reuse using only 3 frequencies. In FIG. 2, different types of control information or logical control channels have been indicated. In block B0, broadcast information is transmitted on a logical Broadcast Channel (BCCH) and, for example, in block C9, logical Common Control Channels (CCCH) is transmitted (e.g., paging messages). The structure of the control channel is such that more blocks than those indicated can be allocated for broadcast or control. Allocation of 2-12 blocks is possible on a single timeslot. One broadcast information block and once common control block is always needed.

In U.S. patent application Ser. No. 09/472,882, entitled “Methods and Apparatus for Performing Slot Hopping of Logical Control Channels in Wireless Communications System”, by Persson et al, a method to perform slot hopping for the control channel transmissions in a Compact system is disclosed. This application, which is incorporated herein by reference, describes how time groups rotate their allocation position between, for example, TS7, TS5, TS3, TS1, TS7, etc.

So far, the evolution of cellular packet data communications has focused on developing a system that efficiently utilizes resources to transfer delay-insensitive data (often referred to as best-effort data). The natural extension is to also consider delay-sensitive transmissions and higher quality of service requirements. The main application in this regard is voice communications. However, there are several additions required to support real-time applications in a packet data system designed for “best-effort” data.

Voice over Circuit-switched GSM may today be built upon a speech codec solution called Adaptive Multi-Rate (AMR). Essentially, the AMR codec uses more or less channel protection modulation symbols, and more or less voice representation symbols, dependent upon the quality of the radio channel. Furthermore, GSM may also deploy a Half-Rate (HR) codec, which is basically a codec mode that requires only half of the transmission resources required for an ordinary Full-Rate (FR) codec. Presently, discussions are ongoing about how to adapt, for example, AMR, HR and FR, and other different modes to use also in packet-switched systems.

However, there is still another difficulty with the above-described Compact system. With real-time applications over a packet data system, there must be a provision for the possibility to continuously allocate packet channels. In a Compact system, this is possible only on even-numbered timeslots. The odd-numbered timeslots are either being idle to provide for a higher reuse in a co-frequency cell, or control channel transmissions occur at certain repetitions, which makes it more or less impossible to continuously allocate, for example, voice resources for a real-time application. It would be advantageous if the resources that are not used for common control or broadcast transmissions on the odd-numbered timeslots also could be used for real-time applications. As described below, the present invention successfully resolves the above-described problem.

### SUMMARY OF THE INVENTION

In accordance with a first embodiment of the present invention, a method for continuous allocation of real-time traffic in a TDMA communication system employing a discontinuous control channel is provided, whereby a network allocates, for a timeslot or other medium, a unique radio block for real-time traffic that immediately succeeds a control block (or block otherwise non-allocable for real-time traffic) which is also allocated for that timeslot. The unique radio block is allocated to carry the unit of real-time traffic displaced by the control block, along with the next unit of real-time traffic. For this embodiment, the two units of real-time traffic in the allocated radio block are each conveyed in a half-rate mode, while the real-time traffic in a normal radio block is conveyed in a full-rate mode. In accordance with a second embodiment, a two-timeslot allocation is used. If a control block is allocated for one of the two timeslots, a unique radio block is allocated for the second timeslot for the time interval to be occupied by the control block in the first timeslot. The unique radio block is allocated to convey the unit of real-time traffic displaced by the control block from the first timeslot, along with the unit of real-time traffic allocated for the second timeslot. The unit displaced by the control block, and the unit allocated for the second timeslot, may or may not originate from or be addressed to different users. Similar to the first embodiment, each unit of real-time traffic in the unique radio block is conveyed in the half-rate mode. A third embodiment allows continuous allocation of real-time traffic in a timeslot with continuous half-rate channel transmissions. In yet another aspect of the present invention, a user that is allocated on a timeslot where a continuous stream of speech packets may not be scheduled, can receive or transmit any non-schedulable speech packet on a transmission resource that may be shared with at least one other user. Both these users may, to enable the continuity of the communication, be requested to, during this period, decrease the transmission rate. Using the above-described approaches, the output signals of, for example, a speech codec can be continuously allocated for transmission.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is an exemplary diagram that illustrates a 1/3 reuse pattern;

FIG. 2 is a diagram that illustrates a typical allocation for control channels in a mobile communications system;

FIG. 3 is a block diagram of a portion of an exemplary combined GPRS and TDMA/136 communications system, which can be used to implement the present invention;

FIG. 4 is a diagram that illustrates a method for encoding radio transmissions, which can be used to implement a first embodiment of the present invention;

FIG. 5 is a diagram that illustrates a method for encoding radio transmissions, which can be used to implement a second embodiment of the present invention; and

FIG. 6 is a diagram that illustrates a method for encoding radio transmissions, which can be used to implement a third embodiment of the present invention.

### DETAILED DESCRIPTION OF THE DRAWINGS

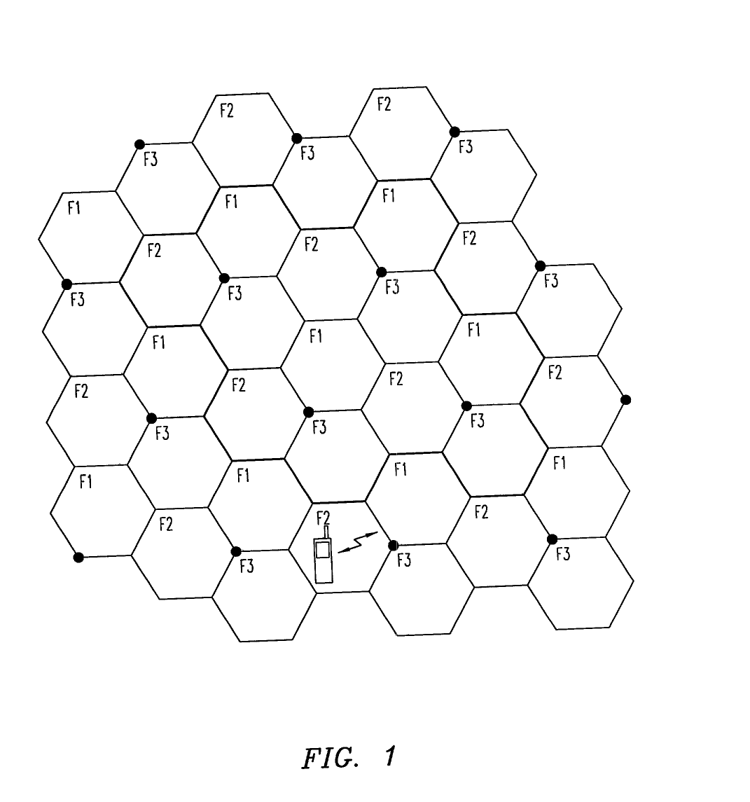

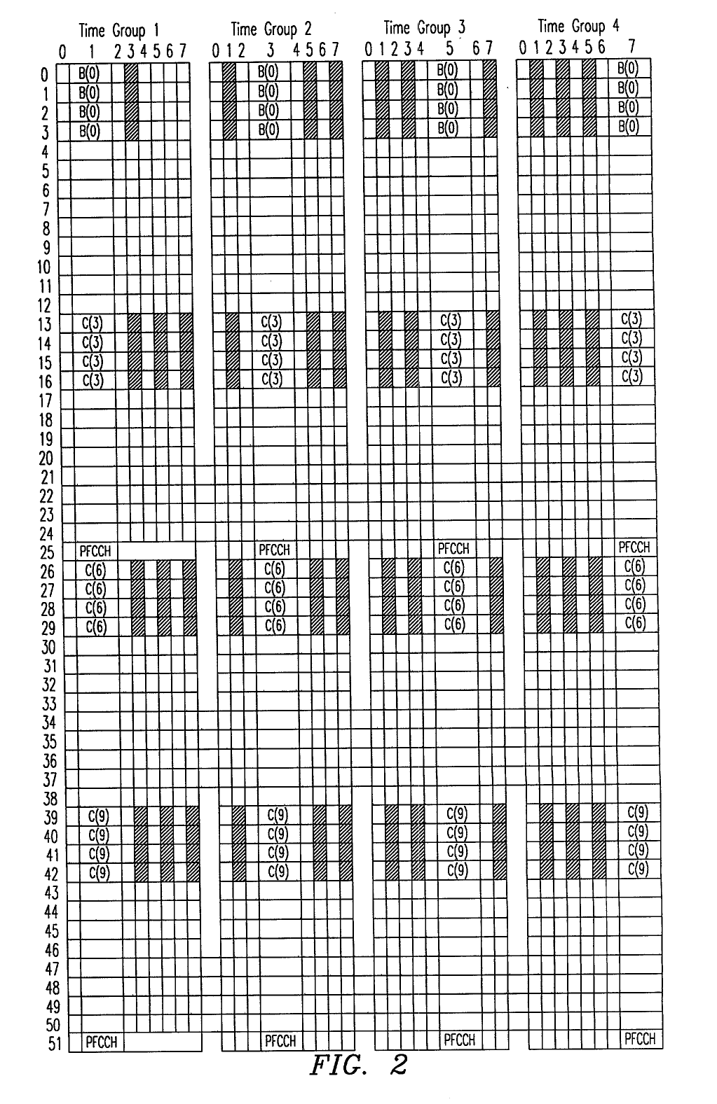

The preferred embodiment of the present invention and its advantages are best understood by referring to FIGS. 1-6 of the drawings, like numerals being used for like and corresponding parts of the various drawings.

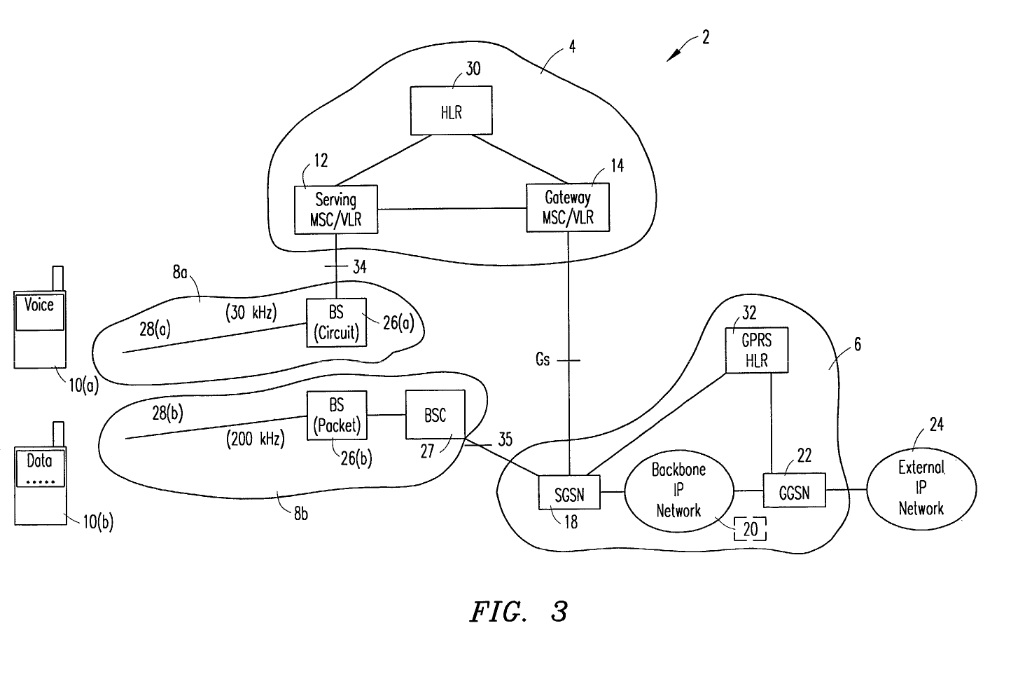

Referring now to FIG. 3, there is illustrated a block diagram of an exemplary mobile telecommunications system 2 in which the present invention can be implemented. In particular, system 2 is a combined GPRS and TDMA/136 system, although it will be recognized by those skilled in the art that the invention is also applicable in other types of telecommunications systems, such as for example, GSM. In addition, system 2 supports EGPRS technology (i.e., new modulation format). The mobile telecommunications system 2 includes a circuit-switched network 4 and a packet-switched network 6. A first radio network 8a is connected to the circuit-switched network 4, and a second radio network 8b is connected to the packet-switched network 6. Radio network 8a is based on TDMA/136 radio technology and radio carriers of 30 kHz bandwidth. Radio network 8b is based on GSM and GPRS radio technology and radio carriers of 200 kHz bandwidth. Generally, the circuit-switched network 4 is used primarily for voice applications, while the packet-switched network 6 is used primarily for data applications. However, the invention is mainly focused on real-time applications (e.g., voice) for the packet-switched radio network part 8b.

The circuit-switched network 4 includes a plurality of mobile switching center/visitor location registers (MSC/VLRs) 12. For the purpose of simplifying the illustration, however, only one MSC/VLR 12 is shown. Each MSC/VLR 12 serves a particular geographic region and is used for controlling communications in the served region and routing communications to other MSC/VLRs 12. The VLR portion of the MSC/VLR 12 stores subscriber information relating to mobile stations 10a that are currently located in the served region. Furthermore, the circuit-switched network 4 includes at least one gateway MSC/VLR 14 that can function to interconnect the circuit-switched network 4 with other networks (e.g., packet-switched network 6).

The packet-switched network 6 includes a plurality of serving GPRS support nodes (SGSNs) 18, which are used for routing and controlling packet data communications, and a backbone IP network 20. A gateway GPRS support node (GGSN) 22 interconnects the packet-switched network 6 with an external IP network 24 or other external data networks.

The radio networks 8a and 8b include a plurality of cells. Each cell in the mobile telecommunications system 2 is served by a base station 26 that communicates with mobile stations 10a and 10b, wherein mobile station 10a supports at least circuit-switched communications over a 30 kHz radio channel, and mobile station 10b supports at least packet-switched communications over a 200 kHz radio channel via air interfaces 28a and 28b, respectively.

Radio network 8a can include a plurality of base stations connected to the MSC/VLR 12. Radio network 8b further includes a Base Station Controller (BSC) 27, which can control a plurality of base stations 26b. For circuit-switched communications, signals are routed from the MSC/VLR 12 to the base station 26a for the cell in which the target mobile station 10a is currently located, and over the air interface 28a to the mobile station 10a. On the other hand, for packet data transmissions, signals are routed from the SGSN 18 to the radio network controller 27 via a Gb-interface 35, to the base station 26b for the cell in which the target mobile station 10 is currently located, and over the air interface 28b to the mobile station 10b. Note that the mobile stations 10a and 10b can be parts of the same physical user equipment (e.g., a mobile station including both a circuit-switched and packet-switched part).

Each mobile station 10a or 10b is associated with a home location register (HLR) 30 or 32, respectively. The HLR 30 stores subscriber data for the mobile station 10a, and the HLR 32 stores subscriber data for the mobile station 10b. The HLR 32 is associated with subscriber information about the packet-switched services, and the HLR 30 is associated with subscriber information about the circuit-switched services. Consequently, the HLR 30 can be accessed by the MSC/VLRs 12 to retrieve subscriber data relating to circuit-switched services. Similarly, the HLR 32 can be accessed by the SGSN 18 to retrieve subscriber data relating to packet-switched services.

In the packet-switched part of mobile telecommunications system 2, packet-switched communications are sent via the air interface 28b using one or more timeslots. In many cases, each timeslot is allocated to several mobile stations (i.e., different users can be multiplexed on the same timeslot and make alternate use of it). The multiplexing periods during which data is sent in EGPRS is in radio blocks. The radio blocks correspond to the duration of four “frames” in the GSM TDMA structure. One such frame is composed of eight timeslots, and takes about 4.6 ms to send. Consequently, one radio block takes about 20 ms to send. Note that one radio block is defined on a per timeslot basis. Therefore, in 20 ms, eight radio blocks are actually sent, but on different timeslots.

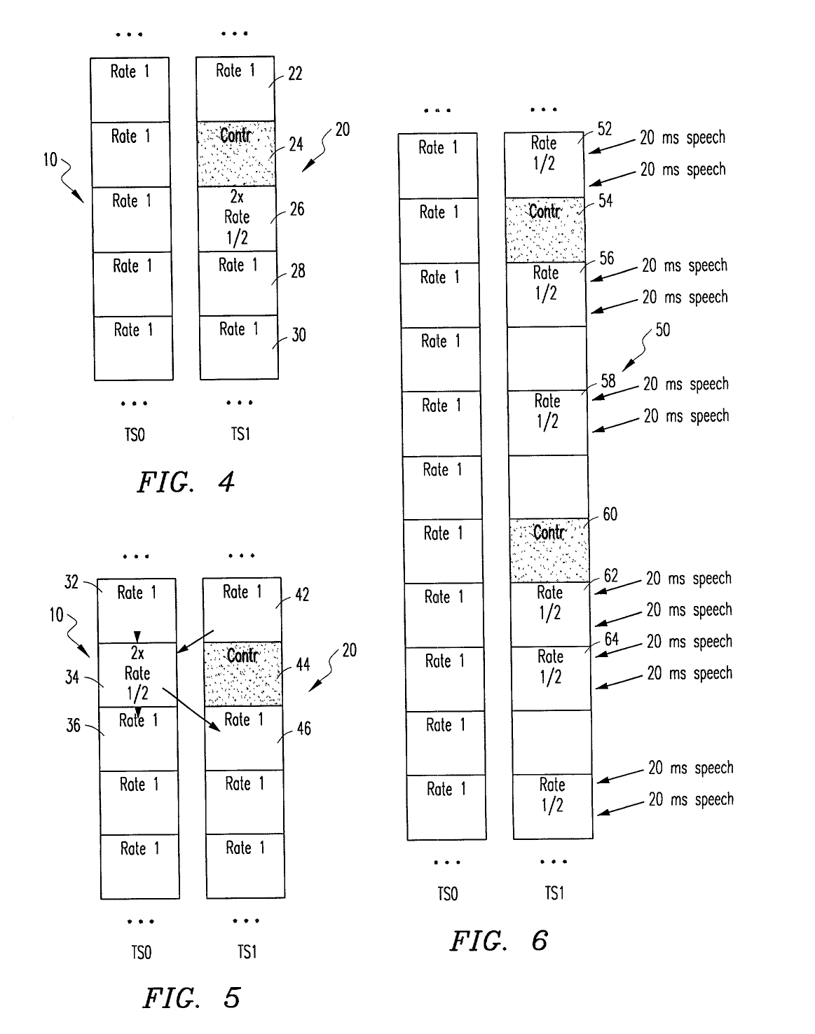

FIG. 4 is a diagram that illustrates a method for encoding radio transmissions, which can be used to implement a first embodiment of the present invention. For this exemplary embodiment, a representation of portions of two radio transmission timeslots TS0 (10) and TS1 (20) is shown. Although two such timeslots are shown, the method of the first embodiment can be readily illustrated with respect to one timeslot (in this case, TS1 or 20). However, the inventive principles described herein with respect to the one timeslot (e.g., TS1 or 20) can also be applied with respect to another timeslot (e.g., TS0 or 10).

As discussed above, an important purpose of the present method is to enable an operator of a combined EGPRS and TDMA/136 or similar type of network (including a GPRS part) in a system to allocate continuous services, such as speech or video conferences, for radio transmission traffic on discontinuous packet-switched timeslots. In other words, a continuous application can be transmitted on a radio channel or timeslot which is frequently interrupted by other transmissions, such as for example, a broadcast control channel. In this regard, the timeslot TS1 (20) shown in FIG. 4 illustrates a method for allocating radio blocks on timeslots that allows the continuous radio transmission of traffic information even if one or more blocks of a timeslot have been allocated for control information, or are otherwise not allocable for radio transmission traffic. For example, the timeslot TS1 (20) includes radio blocks 22, 28 and 30, which (for this exemplary embodiment) are allocated for and can carry 20 ms of real-time information, such as speech, in a full-rate mode (Rate 1). The timeslot TS1 (20) can, for example, be allocated for a VoIP traffic session, or more generally, for a voice over packet data traffic session.

For this embodiment, an appropriate coder/decoder (codec) is included for both the network (e.g., 8b) and the terminal (e.g., mobile station 10b) . Also, it can be assumed for this embodiment that the timeslot TS0 (10) is transmitted for one user (e.g., terminal 10b), and the timeslot TS1 (20) is transmitted for another user (a “b” part of a different mobile station) . In other words, as mentioned above, the timeslot TS1 (20) has, for this example, been allocated by the network 8b to the user of terminal 10b for a voice over packet data communications session. Also, the timeslot TS1 is arranged to share traffic channel transmissions with control channel transmissions.

Referring to FIGS. 3 and 4, the timeslot TS1 (20) is allocated for transmission to terminal 10b with blocks 22, 28 and 30 including 20 ms of speech data (e.g., output from the network speech codec) conveyed in a full-rate mode (Rate 1). As the network allocates a control block 24 for transmission in timeslot TS1 (20), a buffer at the network side is used to store the next output unit (20 ms of speech data) from the network speech codec, allocate that (20 ms) speech data for the next radio block 26 to be conveyed in a half-rate mode (Rate ½), and allocate the next unit output (the next 20 ms of speech data) from the network speech codec for the same radio block 26 in the half-rate mode. In other words, two consecutive unit outputs of speech data from the network speech codec are allocated for one radio block (26) to compensate for the block 24, which has been allocated to convey control channel information. In this way, the speech information can be continuously allocated for transmission even when a control block (or other type of non-traffic block) has been allocated for transmission in the same timeslot. Albeit, the present method can reduce the overall rate of the communication session somewhat because of the speech transmissions occurring at the half-rate mode. However, the overall performance of the session is much higher than if 20 ms of speech data from the codec had not been allocated or transmitted at all.

It is preferable to allocate only one traffic block for use in the half-rate mode, for one control block immediately preceding that particular traffic block. Consequently, from a practical standpoint, it is advantageous to provide a 20 ms delay prior to speech decoding (e.g., at the codec in the terminal 10). This approach introduces a constant 20 ms delay, which is better for speech codec performance than introducing a variable delay.

FIG. 5 is a diagram that illustrates a method for allocating radio transmissions, which can be used to implement a second embodiment of the present invention. Referring to FIGS. 3 and 5, for this exemplary embodiment, one or more of the terminals 10 is a multi-slot capable terminal. As such, it can be assumed that a first terminal (e.g., mobile station 10b) is capable of transmitting and receiving information via two allocated timeslots, such as TS0 (30) and TS1 (40). As shown, blocks 32 and 42 are allocated to carry speech information in a full-rate mode. During the time interval when the control block 44 is allocated for transmission, the first user (e.g., terminal 10b) receiving traffic from timeslot TS1 (40) is enabled to share timeslot TS0 (30) with a second user (e.g., the “b” part of a different mobile station) that has been receiving traffic on that timeslot (30). As such, during the period when the control block 44 is allocated for transmission on timeslot TS1 (40), the speech traffic destined for the first terminal 10b during that period is allocated to the speech block 34 of the timeslot TS0 (30) in the half-rate mode. Also during that same time period, the speech traffic destined for the second terminal is also allocated to the block 34 of the timeslot TS0 (30) in the half-rate mode, thus sharing block 34 with the first terminal. Consequently, the radio block 34 includes the two half-rate 20 ms intervals of speech traffic destined for the two terminals 10. Subsequently, the speech traffic destined for the two terminals 10 is again allocated to the respective blocks 36, 46 in the respective timeslots TS0 (30) and TS1 (40) in the full-rate mode. An advantage of the second embodiment over the first embodiment is that the second method can be applied for numerous consecutive control blocks. However, the second embodiment preferably utilizes a multi-slot terminal, which is not required for implementing the first embodiment. Also, the first embodiment is more favorable than the second embodiment in terms of coding and robustness, because for the first embodiment, the same interleaving depth (e.g., 4) can be maintained in the half-rate block, while a lesser period of interleaving depth must be used in the uplink for the second embodiment. The downlink transmission can be interleaved during the entire radio block period, or alternatively, asymmetric links can be derived by using shorter periods of interleaving in the downlink as well as the uplink.

FIG. 6 is a diagram that illustrates a method for allocating radio transmissions, which can be used to implement a third embodiment of the present invention. Essentially, the method employed for the first embodiment can be used for the third embodiment if the network allocates half-rate channels continuously for traffic. For example, as shown in FIGS. 3 and 6, for this embodiment, the network side continuously allocates every other block for half-rate channels (e.g., 52, 56, 58) for a user (e.g., terminal 10b) on the timeslot TS1 (50). However, if the “every other block” sequence is interrupted (e.g., by a control block 60 or other block not applicable for traffic), then the user (e.g., terminal 10b) of the timeslot TS1 (50) has to further “listen” to the next consecutive radio block(s). As such, when a control block (e.g., 60) is allocated to a block position interrupting the sequence, the speech traffic (e.g., 20 ms of speech output from the network codec) for that interval is displaced to the next block position and is stored and allocated for transmission on the succeeding radio block (e.g., 62) possibly along with the speech traffic (e.g., 20 ms of speech) normally allocated to that radio block. In this case, when a control block is allocated for an interval when a radio block would normally occur (e.g., 60), then the user of that timeslot has to further “listen” for a pair of consecutive timeslots (e.g., 62, 64).

Notably, as mentioned earlier, from a practical standpoint (not a limitation of the invention), the embodiments described herein are associated with a delay (e.g., 20 ms) which is preferably controlled and implemented at the network side. However, there are other delays that can occur which are not controllable by the network. For example, delays associated with packets being received in the wrong order, or packets that have been delayed significantly so that they are not useful as an output from a speech decoder can be handled by the methods described in U.S. patent application Ser. No. 09/312,557, filed May 14, 1999 to Sundquist et al.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims. In particular, the present invention can be used generally when “stealing” blocks originally allocated to real-time data.

What is claimed is:

1. A method for continuous allocation of real-time traffic in a communication network, comprising the steps of:
allocating a first unit of real-time data for transmission during a first interval with a first transmission rate;
allocating non-real-time data for transmission during a second interval;
allocating a second unit of real-time data for transmission during a third interval with a second transmission rate; and
allocating a third unit of real-time data for transmission during said third interval with said second transmission rate.

2. The method of claim 1, wherein said real-time data includes speech data.

3. The method of claim 1, wherein each said first unit, second unit and third unit of real-time data comprises a respective 20 ms signal output from a speech codec.

4. The method of claim 1, wherein said communication network comprises a TDMA communication network.

5. The method of claim 1, wherein each of said intervals comprises a block in a timeslot.

6. The method of claim 1, wherein said first transmission rate comprises a transmission at a full-rate.

7. The method of claim 1, wherein said first transmission rate is a higher rate than said second transmission rate.

8. The method of claim 1, wherein said second transmission rate comprises a transmission at a half-rate.

9. The method of claim 1, wherein said non-real-time data comprises control data.

10. A method for continuous allocation of real-time traffic in a communication network, comprising the steps of:
allocating a first unit of real-time data for transmission during a first interval with a first transmission rate;
allocating non-real-time data for transmission during a second interval;
allocating a second unit of real-time data for transmission during said second interval with a second transmission rate; and
allocating a third unit of real-time data for transmission during said second interval with said second transmission rate.

11. The method of claim 10, wherein the step of allocating said non-real-time data further comprises allocating said non-real-time data for a first timeslot, and the steps of allocating said second unit of real-time data and said third unit of real-time data further comprises allocating said second unit of real-time data and said third unit of real-time data for a second timeslot.

12. The method of claim 10, wherein said first and second units of real-time data are allocated to a first user, and said third unit of real-time data is allocated to a second user.

13. The method of claim 10, wherein said real-time data includes speech data.

14. The method of claim 10, wherein each of said first unit, second unit and third unit of real-time data comprises a respective 20 ms signal output from a speech codec.

15. The method of claim 10, wherein said communication network comprises a TDMA communication network.

16. The method of claim 10, wherein said communication network comprises a Compact EDGE network.

17. The method of claim 10, wherein each of said intervals comprises a block in one or more timeslots.

18. The method of claim 10, wherein said first transmission rate comprises a transmission at a full-rate.

19. The method of claim 10, wherein said first transmission rate is a higher rate than said second transmission rate.

20. The method of claim 10, wherein said second transmission rate comprises a transmission at a half-rate.

21. The method of claim 10, wherein said non-real-time data comprises control data.

22. A method for continuous allocation of real-time traffic in a communication network, comprising the steps of:
allocating a first unit of real-time data for transmission during a first interval with a predetermined transmission rate;
allocating a second unit of real-time data for transmission during said first interval;
allocating non-real-time data for transmission during a second interval;
determining if said second interval is not contiguous with said first interval; and
if said second interval is not contiguous with said first interval, allocating a third unit of real-time data and a fourth unit of real-time data for transmission during a third interval with said predetermined transmission rate, and allocating a fifth unit of real-time data and a sixth unit of real-time data for transmission during a fourth interval with said predetermined transmission rate, said third interval contiguous with said second interval, and said fourth interval contiguous with said third interval.

23. The method of claim 22, wherein said first unit of real-time data includes speech data.

24. The method of claim 22, wherein each of said first unit, second unit, third unit, fourth unit, fifth unit and sixth unit of real-time data comprises a 20 ms signal output from a speech codec.

25. The method of claim 22, wherein said communication network comprises a TDMA communication network.

26. The method of claim 22, wherein said communication network comprises a Compact EDGE network.

27. The method of claim 22, wherein each of said intervals comprises a block in a timeslot.

28. The method of claim 22, wherein said predetermined transmission rate comprises a transmission at a half-rate.

29. The method of claim 22, wherein said non-real-time data comprises control data.

30. A system for continuous allocation of real-time traffic, comprising:
a network control unit; and
a terminal unit coupled to said network control unit by a transmission medium, said network control unit further comprising:
means for allocating a first unit of real-time data for transmission during a first interval with a first transmission rate;
means for allocating non-real-time data for transmission during a second interval;
means for allocating a second unit of real-time data for transmission during a third interval with a second transmission rate; and
means for allocating a third unit of real-time data for transmission during said third interval with said second transmission rate.

31. The system of claim 30, wherein said first unit of real-time data includes speech data.

32. The system of claim 30, wherein each of said first unit, second unit and third unit of real-time data comprises a 20 ms signal output from a speech codec.

33. The system of claim 30, wherein said system comprises a TDMA communication system.

34. The system of claim 30, wherein said system comprises a Compact EDGE communication system.

35. The system of claim 30, wherein each of said intervals comprises a block in a timeslot.

36. The system of claim 30, wherein said first transmission rate comprises a transmission at a full-rate.

37. The system of claim 30, wherein said first transmission rate is higher than said second transmission rate.

38. The system of claim 30, wherein said second transmission rate comprises a transmission at a half-rate.

39. The system of claim 30, wherein said non-real-time data comprises control data.

40. A system for continuous allocation of real-time traffic, comprising:
a network control unit; and
a terminal coupled to said network control unit by a transmission medium, said network control unit further comprising:
means for allocating a first unit of real-time data for transmission during a first interval with a first transmission rate;
means for allocating non-real-time data for transmission during a second interval;
means for allocating a second unit of real-time data for transmission during said second interval with a second transmission rate; and
means for allocating a third unit of real-time data for transmission during said second interval.

41. A system for continuous allocation of real-time traffic, comprising:
a network control unit; and
a terminal coupled to said network control unit by a transmission medium, said network control unit further comprising:
means for allocating a first unit of real-time data for transmission during a first interval with a predetermined transmission rate;
means for allocating a second unit of real-time data for transmission during said first interval;
means for allocating non-real-time data for transmission during a second interval;
means for determining if said second interval is not contiguous with said first interval, and if said second interval is not contiguous with said first interval, allocating a third unit of real-time data and a fourth unit of real-time data for transmission during a third interval with said predetermined transmission rate, and allocating a fifth unit of real-time data and a sixth unit of real-time data for transmission during a fourth interval with said predetermined transmission rate, said third interval contiguous with said second interval, and said fourth interval contiguous with said third interval.
